(19) United States
(12) Patent Application Publication
(10) Pub. No.: US 2022/0114722 A1
(43) Pub. Date: Apr. 14, 2022

(54) CLASSIFIER USING DATA GENERATION

(71) Applicant: SMITHS DETECTION FRANCE S.A.S., Vitry Sur Seine (FR)

(72) Inventors: Pierre MERIGUET, Vitry Sur Seine (FR); Luis TOBIAS, Vitry Sur Seine (FR); Najib GADI, Vitry Sur Seine (FR); Laurent COHEN, Paris (FR); Jamal ATIF, Paris (FR)

(21) Appl. No.: 17/423,593

(22) PCT Filed: Jan. 15, 2020
(86) PCT No.: PCT/GB2020/050081

§ 371 Date: Jul. 16, 2021

(30) Foreign Application Priority Data
Jan. 17, 2019 (GB) 1900672.5

(51) Int. Cl. G06T 7/00; G06V 10/774

(52) U.S. Cl. CPC G06T 7/0008; G06V 10/7747; G06T 2207/20084; G06T 2207/30112; G06T 2207/20081

(57) ABSTRACT

A method is disclosed of generating a classifier configured to detect an object corresponding to a type of interest in an inspection image generated using penetrating radiation, the method including generating training data associated with a plurality of training images including objects corresponding to the type of interest, using a generative adversarial network including a generator and a discriminator. The method further includes training the classifier by applying a machine learning algorithm either using only the generated training data or a combination of real and generated data, wherein generating the training data includes training the generator and the discriminator using initial training data associated with a plurality of observed images generated using penetrating radiation, one or more observed images including an object corresponding to the type of interest.

### CROSS-REFERENCE TO RELATED APPLICATIONS

This patent application is a National Stage Entry of PCT/GB2020/050081 filed on Jan. 15, 2020, which claims priority to GB Application No. 1900672.5 filed on Jan. 19, 2019, the disclosures of which are hereby incorporated by reference herein in their entirety as part of the present application.

### BACKGROUND

The disclosure relates but is not limited to generating a classifier configured to detect an object corresponding to a type of interest in an inspection image generated using penetrating radiation. The disclosure also relates but is not limited to determining whether or not an object corresponding to a type of interest is present in an inspection image generated using penetrating radiation. The disclosure also relates but is not limited to producing a device configured to determine whether or not an object corresponding to a type of interest is present in an inspection image generated using penetrating radiation. The disclosure also relates but is not limited to corresponding devices and computer programs or computer program products.

Inspection images of containers containing cargo may be generated using penetrating radiation. In some examples, a user may want to detect objects corresponding to a type of interest, such as a threat (such as a weapon, an explosive material or a radioactive material) or a contraband product (such as drugs or cigarettes) on the inspection images. Detection of such objects may be difficult. In some cases, the object may not be detected at all. In cases where the detection is not clear from the inspection images, the user may inspect the container manually, which may be time consuming for the user.

### BRIEF DESCRIPTION

Aspects and embodiments of the disclosure are set out in the appended claims. These and other aspects and embodiments of the disclosure are also described herein.

Any feature in one aspect of the disclosure may be applied to other aspects of the disclosure, in any appropriate combination. In particular, method aspects may be applied to device and computer program aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Embodiments of the present disclosure will now be described, by way of example, with reference to the accompanying drawings, in which:

FIG. 1 shows a flow chart illustrating an example method according to the disclosure;

FIG. 2 schematically illustrates an example system and an example device configured to implement the example method of FIG. 1;

FIG. 3 illustrates an example inspection image according to the disclosure;

FIG. 4 schematically illustrates example generated training images;

FIG. 5 shows a flow chart illustrating a detail of the example method of FIG. 1;

FIG. 6 schematically illustrates an example generative adversarial network configured to implement the example method of FIG. 1;

FIG. 7 schematically illustrates example synthetized objects;

FIG. 8 shows a flow chart illustrating another example method according to the disclosure; and

FIG. 9 shows a flow chart illustrating another example method according to the disclosure.

In the figures, similar elements bear identical numerical references.

### DETAILED DESCRIPTION

The disclosure discloses an example method for generating a classifier configured to detect an object corresponding to a type of interest in an inspection image generated using penetrating radiation (e.g. x rays, but other penetrating radiation is envisaged). In typical examples, the type of interest may be a threat, such as a weapon (e.g. a gun or a rifle), an explosive material, a radioactive material, and/or the type of interest may be a contraband product, such as drugs or cigarettes as non-limiting examples.

The disclosure also discloses an example method for determining whether or not an object corresponding to the type of interest is present in an inspection image generated using penetrating radiation.

The disclosure also discloses an example method for producing a device configured to determine whether or not an object corresponding to the type of interest is present in an inspection image generated using penetrating radiation.

The disclosure also discloses corresponding devices and computer programs or computer program products.

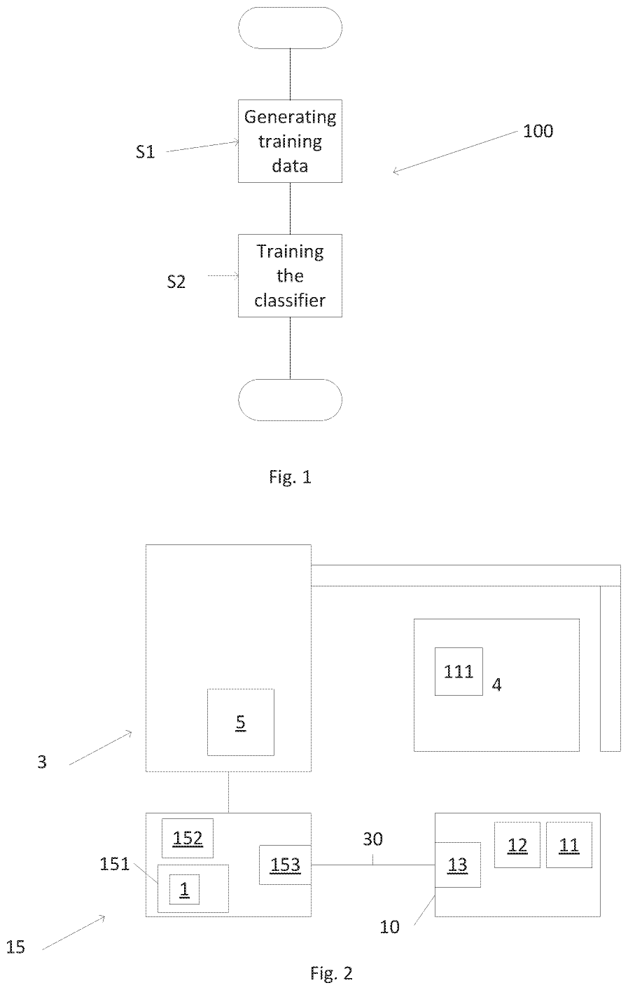

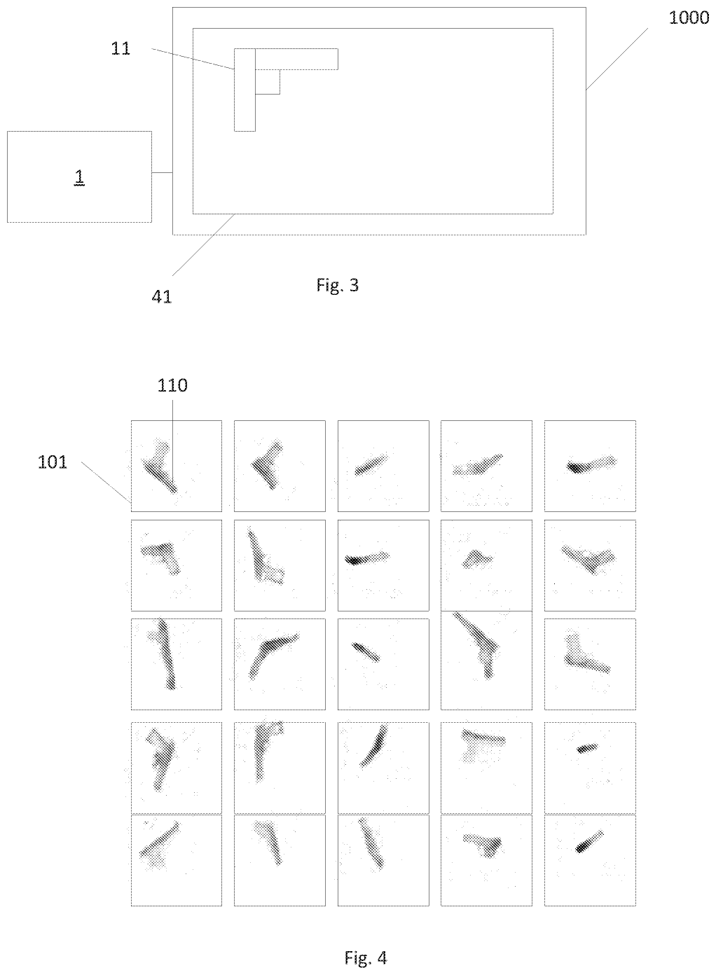

FIG. 1 shows a flow chart illustrating an example method 100 according to the disclosure for generating a classifier 1 illustrated in FIGS. 2 and 3. FIG. 2 also shows a device 15 configurable by the method 100 to determine whether or not an object 11 corresponding to a type of interest is present in an inspection image 1000, shown in FIG. 3. The inspection image 1000 is generated using penetrating radiation, e.g. by the device 15. The method 100 illustrated in FIG. 1 is also described in connection with FIG. 4, showing a plurality of generated training images 101 including objects 110 corresponding to the type of interest, for training the classifier 1.

The method 100 of FIG. 1 includes in overview:

generating, at S1, training data including the plurality of training images 101 including the objects 110 corresponding to the type of interest; and

training, at S2, the classifier 1 by applying a machine learning algorithm, using the generated training data.

As disclosed in greater detail later, the training of the classifier 1 may be performed either using the generated training data or a combination of observed (i.e. real) training data and the generated training data.

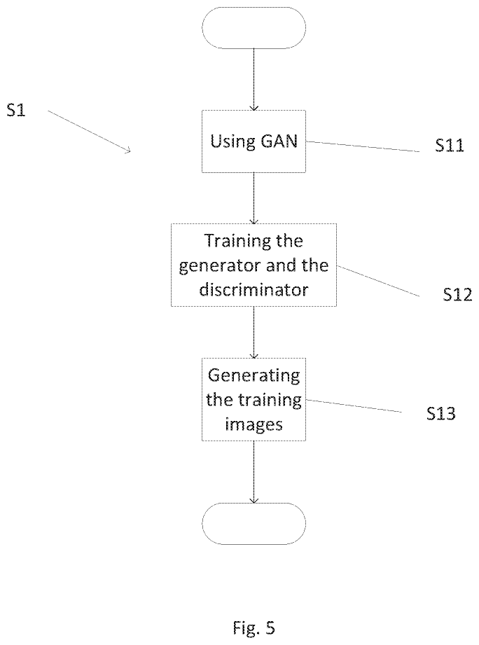

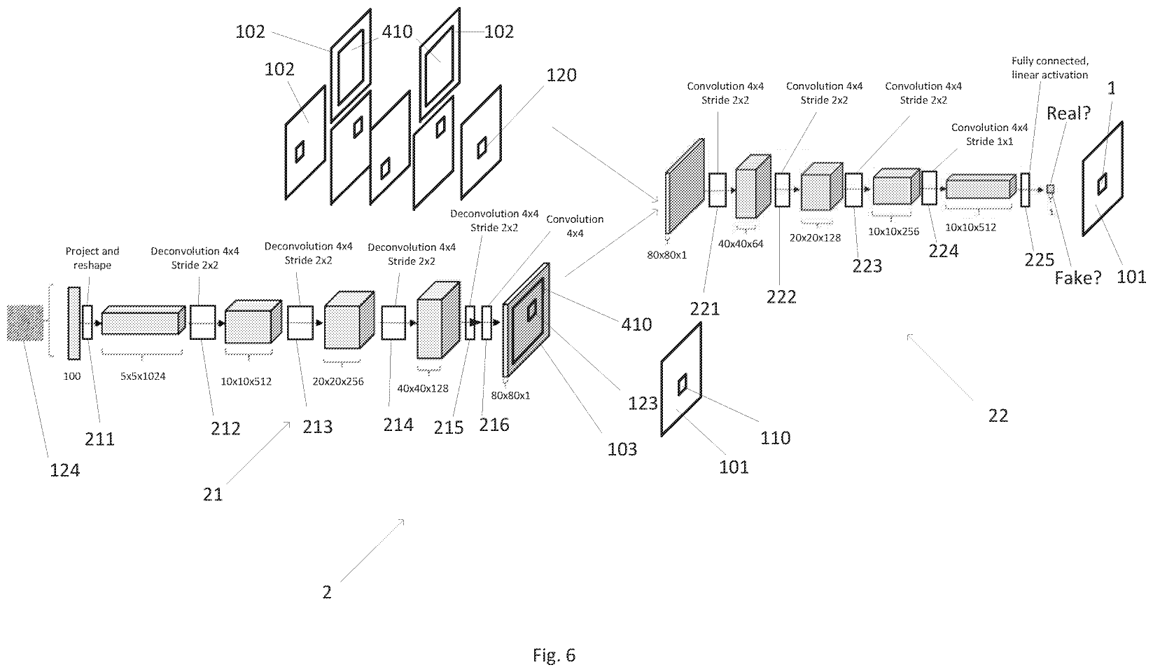

As illustrated in FIG. 5, in some examples generating the training data at S1 may include using, at S11, a generative adversarial network 2, also called GAN 2, including a generator 21 and a discriminator 22, both illustrated in FIG. 6. As described in more detail later, the generator 21 includes a neural network, and the discriminator 22 includes a neural network.

As illustrated in FIG. 5, in some examples generating at S1 the training data may also include training the generator 21 and the discriminator 22 using, at S12, initial training data including a plurality of observed images 102 generated using penetrating radiation, as illustrated in FIG. 6. In some examples, one or more observed images 102 include an observed object 120 corresponding to the type of interest.

Referring back to FIG. 5, in some examples generating at S1 the training data may include, at S13, generating the plurality of training images 101.

As described in more detail later in reference to FIG. 8 showing a method 200, configuration of the device 15 involves storing, e.g. at S22, the classifier 1 at the device 15. In some examples the classifier 1 may be obtained at S21 (e.g. by generating the classifier 1 as in the method 100 of FIG. 1). In some examples, obtaining the classifier 1 at S21 may include receiving the classifier 1 from another data source.

As described above the classifier 1 is derived from the training data using a machine learning algorithm, and is arranged to produce an output indicative of detection or not of an object 11 corresponding to the type of interest in the inspection image 1000.

The classifier 1 is arranged to detect more easily the presence or not of the object 11, after it is stored in a memory 150 of the device 15 (as shown in FIG. 2), even though the process 100 for deriving the classifier 1 from the training data may be computationally intensive.

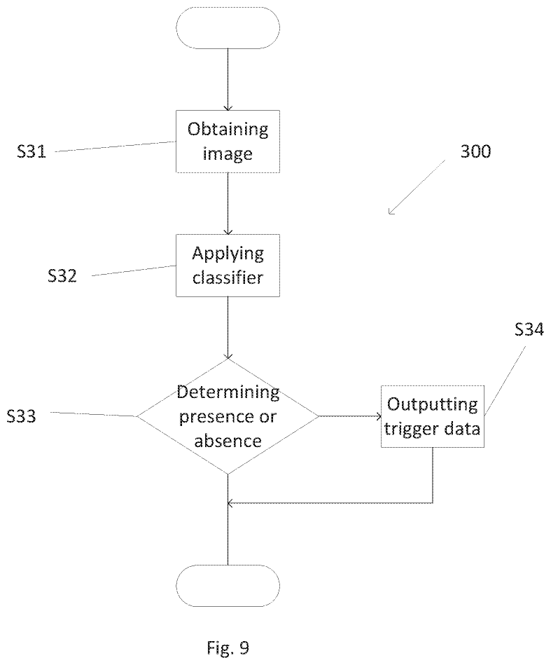

Once configured, the device 15 may provide an accurate detection of the object 11 by applying the classifier 1 to the inspection image 1000. The detection process is illustrated (as process 300) in FIG. 9 (described later).

Computer System and Detection Device

FIG. 2 schematically illustrates an example computer system 10 and the device 15 configured to implement, at least partly, the example method 100 of FIG. 1. In particular, in one embodiment, the computer system 10 executes the machine learning algorithm to generate the classifier 1 to be stored on the device 15. Although a single device 15 is shown for clarity, the computer system 10 may communicate and interact with multiple such devices. The training data may itself be obtained using a plurality of observed images 102 acquired using the device 15 and/or using other, similar devices and/or using other sensors and data sources.

The computer system 10 of FIG. 2 includes a memory 11, a processor 12 and a communications interface 13.

The system 10 may be configured to communicate with one or more devices 15, via the interface 13 and a link 30 (e.g. Wi-Fi connectivity, but other types of connectivity may be envisaged).

The memory 11 is configured to store, at least partly, data, for example for use by the processor 12. In some examples the data stored on the memory 11 may include data such as the training data (and the data used to generate the training data) and/or the GAN 2 and/or the machine learning algorithm.

In some examples, the processor 12 of the system 10 may be configured to perform, at least partly, at least some of the steps of the method 100 of FIG. 1 and/or the method 200 of FIG. 8 and/or the method 300 of FIG. 9.

The detection device 15 of FIG. 2 includes a memory 151, a processor 152 and a communications interface 153 (e.g. Wi-Fi connectivity, but other types of connectivity may be envisaged) allowing connection to the interface 13 via the link 30.

In a non-limiting example, the device 15 may also include an apparatus 3 acting as an inspection system, as described in greater detail later. The apparatus 3 may be integrated into the device 15 or connected to other parts of the device 15 by wired or wireless connection.

In some examples, as illustrated in FIG. 2, the disclosure may be applied for inspection of a real container 4 containing a real object 111 corresponding to the type of interest. At least some of the methods of the disclosure may include obtaining the observed images 102, e.g. by irradiating, using penetrating radiation, one or more real objects 111 corresponding to the type of interest and/or one or more real containers 4 configured to contain cargo, and detecting radiation from the irradiated one or more real objects 111 and/or the irradiated one or more real containers 4. Alternatively or additionally, at least some of the methods of the disclosure may include obtaining the inspection image 1000 by irradiating, using penetrating radiation, one or more real containers 4 configured to contain cargo, and detecting radiation from the irradiated one or more real containers 4. The irradiating and/or the detecting may be performed using one or more devices configured to inspect the real containers 4.

In other words the apparatus 3 may be used to acquire the plurality of observed images 102 used to generate the training data and/or to acquire the inspection image 1000.

In some examples, the processor 152 of the device 15 may be configured to perform, at least partly, at least some of the steps of the method 100 of FIG. 1 and/or the method 200 of FIG. 8 and/or the method 300 of FIG. 9.

Obtaining the Training Data

Referring back to FIG. 1, the classifier 1 is generated based on the training data generated at S1. The training of the classifier 1 may be performed either using the generated training data or a combination of observed (i.e. real) training data and the generated training data.

The classifier 1 is trained using the training data, each corresponding to an instance when the classification (e.g. “object present” or “object absent”) is known. As described in greater detail later, the training data may include:

the training images 101 of FIGS. 4 and 6 where an object 110 is present, the training images 101 being used on their own or in combination with observed images 102 where an object is present (i.e. “object absent”), and

observed images 102 where no object is present (i.e. “object absent”).

Referring back to FIGS. 5 and 6, the GAN 2 used at S11 includes the generator 21 and the discriminator 22.

In some examples, during the training at S12, the generator 21 may generate synthetized images 103 (i.e. fake images) including synthetized objects 123 (i.e. fake objects), from at least random values (e.g. a random noise 124), based on the initial training data including observed images 102 (i.e. real images) including an observed object 120 (i.e. real object).

The observed images 102 may correspond to past images acquired in situ by the same device 15 that is being configured, e.g. using the apparatus 3 of the device 15 as depicted in FIG. 2. Alternatively, the observed images 102 may have been obtained in a different environment, e.g. using a similar device (or equivalent set of sensors) installed in a different (but potentially similar) environment, or in a controlled test configuration in a laboratory environment.

In some examples, during the training at S12, the discriminator 22 may aim at classifying images including the synthetized images 103 (i.e. fake images) and the observed images 102 (i.e. real images) by their nature, i.e. real or fake.

The generator 21 is configured to try to fool the discriminator 22 that the synthetized images 103 are real. The discriminator 22 is configured to try to classify the synthetized images 103 as fake and the observed images 102 as real.

The generator 21 and the discriminator 22 compete with each other, based on a loss function. The quantification of the success of the generator 21 and of the discriminator 22 during the training at S12 is defined by the loss function. The discriminator 21 is configured to try to minimize the loss function. The generator 22 is configured to try to maximize the loss function.

In some examples, the loss function may be a function of the Euler-Lagrange type.

In some examples, the loss function may include at least one of a least mean square function and/or a combination of weighted Gaussian kernels.

In some examples, combination of the weighted Gaussian kernels includes a combination C(P,Q,D), such that:

$$𝒞 ( P , Q , D ) = 2 - ( {𝔼}_{x \sim P} [ {\sum }_{k = 1}^{n} {w}_{k} {e}^{- \frac{{( 1 - D ( x ) )}^{2}}{{σ}_{k}^{2}}} ] + {𝔼}_{y \sim Q} [ {\sum }_{k = 1}^{n} {w}_{k} {e}^{- \frac{{D ( y )}^{2}}{{σ}_{k}^{2}}} ] )$$

where: n is the number of kernels,

E[X] is the expectation of a X function;

D(x) is the output of the discriminator 22 for an image x,

D(y) is the output of the discriminator 22 for an image y,

P is the probability distribution of the observed images 102,

Q is the probability distribution of the synthetized images 103,

(wk) is a set of positive real numbers such that Σwk=1, and

σk is a set of strictly positive numbers acting as standard deviations parameters for the Gaussian kernels.

In some examples P and Q may be absolutely continuous with respect to a measure. In a non-limiting example, Q may be absolutely continuous with respect to a Lebesgue measure, and P may or may not be absolutely continuous with respect to the Lebesgue measure.

In some examples, the combination C(P,Q,D) includes a barycenter of any number of Gaussian kernels, and, as non-limiting examples, one to thirteen Gaussian kernels, such as three Gaussian kernels, five Gaussian kernels, seven Gaussian kernels or ten Gaussian kernels.

Referring back to FIG. 6, the generator 21 includes one or more deconvolution layers and a transposed convolution layer. The deconvolution layers may have e.g. a kernel size of 4×4 and/or e.g. a stride of 2×2. The kernel size of a layer is the size of the filter applied by the layer that needs to be trained, and the stride of a layer is the distance between two consecutives positions of the kernel while applying the filter to an input to the layer.

As illustrated in FIG. 6, the generator 21 may include a module 211 configured to project and reshape the noise 124. The reshape step may fit the input 124 into a correct size for deconvolution steps that follow. The generator 21 may also include a first module 212, a second module 213, a third module 214 and a fourth module 215. Each module 212, 213, 214 and 215 may be a deconvolution layer. The first module 212 may have e.g. a kernel size of 4×4 and e.g. a stride of 2×2, the second module 213 may have e.g. a kernel size of 4×4 and e.g. a stride of 2×2, the third module 214 may have e.g. a kernel size of 4×4 and e.g. a stride of 2×2, and the fourth module 215 may have e.g. a kernel size of 4×4 and e.g. a stride of 2×2. The generator 21 may also include a fifth module 216. The fifth module 216 may be a transposed convolution layer, with e.g. a kernel size of 4×4. In FIG. 6, the generated images 103 may have a 80×80 size.

Other architectures are also envisaged for the generator 21. For example, deeper architectures may be envisaged and/or an architecture of the same shape as the architecture shown in FIG. 6 that would generate images 103 with sizes different from 80×80 (for example, 120×120, 150×150, 200×200 or multiple channel images) may be envisaged.

Referring back to FIG. 6, the discriminator 22 includes one or more convolution layers, and a fully connected linear activation layer. The convolution layers may include e.g. a kernel size of 4×4 and e.g. a stride of 2×2 or of 1×1.

The discriminator 22 may include a first module 221, a second module 222, a third module 223, a fourth module 224, and a fifth module 225. The first module 221 may have e.g. a kernel size of 4×4 and e.g. a stride of 2×2, the second module 222 may have e.g. a kernel size of 4×4 and e.g. a stride of 2×2, the third module 223 may have e.g. a kernel size of 4×4 and e.g. a stride of 2×2, the fourth module 224 may have e.g. a kernel size of 4×4 and e.g. a stride of 1×1. The fifth module 225 may be a fully connected, linear activation layer.

Other architectures are also envisaged for the discriminator 22. The discriminator 22 is closely tied to the generator 21, and may be modified similarly to the generator 21. Hence, the discriminator 22 may be deeper than the discriminator 22 shown in FIG. 6 and/or adapted to input image sizes other than 80×80.

Referring back to FIGS. 4 to 6, generating, at S13, the plurality of training images 101 may include generating synthetized objects 123 corresponding to the type of interest (e.g. the synthetized objects 123 are generated by the generator 21). In some examples, each synthetized object 123 may be generated using at least a part of an observed object 120 in the one or more observed images 102.

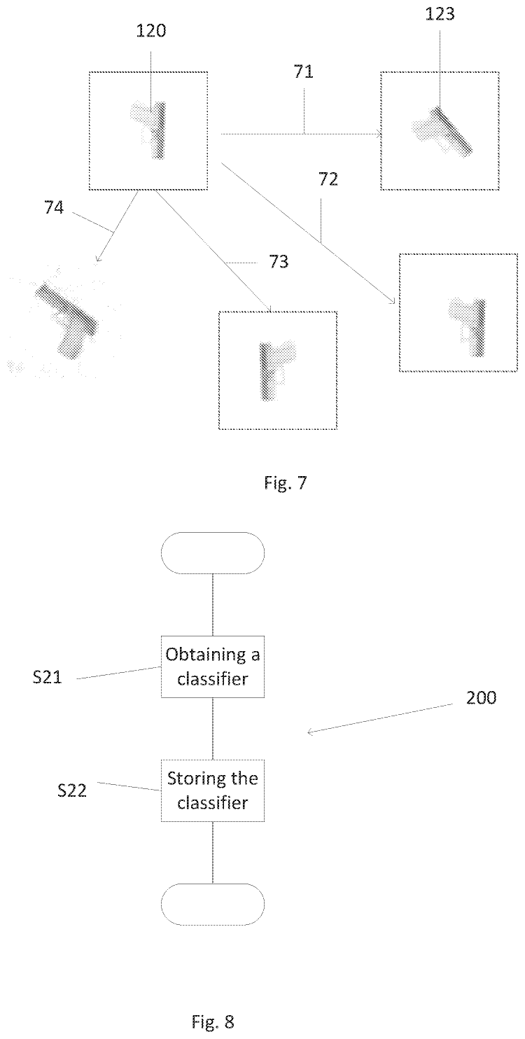

As illustrated in FIG. 7, generating the synthetized objects 123 may include at least one of: rotating (as shown in arrow 71) and/or translating (as shown in arrow 72) and/or flipping (as shown in arrow 73) at least a part of the object 120. Alternatively or additionally, in some examples, generating the synthetized objects 123 may include combining a part of a first object 120 with another part of a second object 120 (as shown in arrow 74), to obtain a new synthetized object 123 corresponding to the type of interest. In some examples the combining represented by the arrow 74 may exploit intermediate points in an appearance manifold of the object 120.

Referring back to FIGS. 2 and 3, the disclosure may be applied, as a non-limiting example, to inspection images 1000 including a representation 41 of a container 4 containing the object 111 corresponding to the type of interest.

In such an example, in the training at S12 of the generator 21 and of the discriminator 22, one or more observed images 102 may include a representation 410 of a container 4. In such an example, generating the synthetized images 103 (and the training images 101 as described below) may include using at least a part of a representation 410 of the container 4 in the one or more observed images 102. In some examples the whole of the representation 410 may be used in the synthetized images 103.

In some examples, generating the synthetized images 103 (and the training images 101) may further include using one or more synthetized objects 123. As illustrated in FIG. 6, the synthetized images 103 may include at least a part of the representation 410 and one or more synthetized objects 123.

In some examples, generating the synthetized images 103 may include using a Beer-Lambert law for combining the at least a part of representation 410 of the container 4 in the one or more observed images 102 and the one or more synthetized objects 123.

The synthetized images 103 classified as real by the discriminator 22 may be used as the training images 101 as part of the training data for the classifier 1, e.g. as part of the training data where the object 110 is present.

Once the generator 21 has been trained, the generator 21 may generate synthetized images 103 that are realistic enough to be used as the training images 101 as part of the training data for the classifier 1, e.g. as part of the training data where the object 110 is present.

The GAN 2 enables generating a great amount of training images 101. In some examples the GAN 2 may generate several thousands of training images 101, for example several hundreds of thousands of training images 101, for examples several millions of training images 101, from a relatively small amount of initial training data including the observed images 102 (such as a few tens of observed images 102 or less). The GAN 2 enables generating training images 101 including realistic objects 110. The GAN 2 enables generating training images 101 including objects 110 which are not in the observed images 102, and the GAN 2 enables adding variability within a range of objects 110 and/or obtaining a greater range of objects 110 in the type of interest.

The generated training images 101, given their great numbers and/or their realistic objects 110 and/or their variability of the objects 110, enable improving the classifier 1.

Generating the Classifier

Referring back to FIG. 1, the classifier 1 is built by applying a machine learning algorithm to the training data. Any suitable machine learning algorithm may be used for building the classifier. For example, approaches based on convolutional neural network may be used.

The learning process is typically computationally intensive and may involve large volumes of training data. In some examples, the processor 12 of system 10 may include greater computational power and memory resources than the processor 152 of the device 15. The classifier generation is therefore performed, at least partly, remotely from the device 15, at the computer system 10. In some examples, at least steps S1 and/or S2 of the method 100 are performed by the processor 12 of the computer system 10. However, if sufficient processing power is available locally then the classifier learning could be performed (at least partly) by the processor 152 of the device 15.

The machine learning step involves inferring behaviours and patterns based on the training data and encoding the detected patterns in the form of the classifier 1.

Referring back to FIGS. 4 and 6, the training data may include the training images 101 obtained by the process at S1.

The classification labels for the training data (specifying known presence or absence states) may be known in advance. In some examples, the training data include the generated training data. The training data may include the training images 101 including one or more object 110 (as illustrated in FIG. 4). The classification label for the training images 101 of FIG. 4 is “object 11 present”. The generated training data may be used on their own or in combination with observed images 102.

The training data also includes training images not including any objects corresponding to the type of interest. The training images not including any objects corresponding to the type of interest may correspond to past data (e.g. past images) acquired in situ by the same device 15 that is being configured, e.g. using the apparatus 3 of the device 15 as depicted in FIG. 2. Alternatively, the past data may have been obtained in a different environment, e.g. using a similar device (or equivalent set of sensors) installed in a different (but potentially similar) environment, or in a controlled test configuration in a laboratory environment. The classification label for the training images not including any objects corresponding to the type of interest may be known in advance (e.g. when training images are derived experimentally in a laboratory setting) or may be obtained using a secondary device. In some examples, a domain specialist may manually label the training images with ground truth classification (e.g. ‘no object’ for an image). The classification label for the training images not including any objects corresponding to the type of interest is “object absent” (i.e. “no object corresponding to the type of interest is present”).

Device Manufacture

As illustrated in FIG. 8, a method 200 of producing the device 15 configured to determine whether or not an object 11 corresponding to a type of interest is present in an inspection image 1000 generated using penetrating radiation, may include:

obtaining, at S21, a classifier 1 generated by the method 100 according to any aspects of the disclosure; and

storing, at S22, the obtained classifier 1 in the memory 151 of the device 15.

The classifier 1 may be stored, at S22, in the detection device 15. The classifier 1 may be created and stored using any suitable representation, for example as a data description including data elements specifying classification conditions and their classification outputs (e.g. presence or absence of the object 11). Such a data description could be encoded e.g. using XML or using a bespoke binary representation. The data description is then interpreted by the processor 152 running on the device 15 when applying the classifier 1.

Alternatively, the machine learning algorithm may generate the classifier 1 directly as executable code (e.g. machine code, virtual machine byte code or interpretable script). This may be in the form of a code routine that the device 15 can invoke to apply the classifier 1.

Regardless of the representation of the classifier 1, the classifier 1 effectively defines a decision algorithm (including a set of rules) for classifying a presence status of the object 11 based on input data (i.e. the inspection image 1000).

After the classifier 1 is generated, the classifier 1 is stored in the memory 151 of the device 15. The device 15 may be connected temporarily to the system 10 to transfer the generated classifier (e.g. as a data file or executable code) or transfer may occur using a storage medium (e.g. memory card). In one approach, the classifier is transferred to the device 15 from the system 10 over the network connection 30 (this could include transmission over the Internet from a central location of the system 10 to a local network where the device 15 is located). The classifier 1 is then installed at the device 15. The classifier could be installed as part of a firmware update of device software, or independently.

Installation of the classifier 1 may be performed once (e.g. at time of manufacture or installation) or repeatedly (e.g. as a regular update). The latter approach can allow the classification performance of the classifier to be improved over time, as new training data becomes available.

Applying the Classifier to Perform Object Detection

Presence or absence classification is based on the classifier 1.

After the device 15 has been configured with the classifier 1, the device 15 can use the classifier based on locally acquired inspection images 1000 to detect whether or not an object 11 is present in the inspection images 1000.

In general, the classifier 1 is configured to detect an object 11 corresponding to a type of interest in an inspection image 1000 generated using penetrating radiation, the inspection image 1000 including one or more features at least similar to the training data used to generate the classifier 1 by the machine learning algorithm.

FIG. 9 shows a flow chart illustrating an example method 300 for determining whether or not an object corresponding to a type of interest is present in an inspection image generated using penetrating radiation. The method 300 is performed by the device 15 (as shown in FIG. 2).

The method 300 includes:

obtaining, at S31, an inspection image 1000;

applying, at S32, to the obtained image 1000, the classifier 1 generated by the method according to any aspects of the disclosure; and

determining, at S33, whether or not an object corresponding to the type of interest is present in the inspection image, based on the applying.

The classifier includes a plurality of output states. In some examples the classifier is configured to output one of: a state corresponding to a presence of an object corresponding to the type of interest in the inspection image, and/or a state corresponding to an absence of an object corresponding to the type of interest in the inspection image.

Optionally the method 300 may further include outputting, e.g. at S34, trigger data to trigger an alarm in response to detecting an object 11 corresponding to the type of interest in the inspection image 1000.

The alarm may include an alarm signal (visual or aural), e.g. for triggering a further detection (e.g. manual inspection) of the container 4 (e.g. for verification).

### Further Details and Examples

The disclosure may be advantageous but is not limited to customs and/or security applications.

The disclosure typically applies to cargo inspection systems (e.g. sea or air cargo).

The apparatus 3 of FIG. 2, acting as an inspection system, is configured to inspect the container 4, e.g. by transmission of inspection radiation through the container 4.

The container 4 configured to contain the cargo may be, as a non-limiting example, placed on a vehicle. In some examples, the vehicle may include a trailer configured to carry the container 4.

The apparatus 3 of FIG. 2 may include a source 5 configured to generate the inspection radiation.

The radiation source 5 is configured to cause the inspection of the cargo through the material (usually steel) of walls of the container 4, e.g. for detection and/or identification of the cargo. Alternatively or additionally, a part of the inspection radiation may be transmitted through the container 4 (the material of the container 4 being thus transparent to the radiation), while another part of the radiation may, at least partly, be reflected by the container 4 (called “back scatter”).

In some examples, the apparatus 3 may be mobile and may be transported from a location to another location (the apparatus 3 may include an automotive vehicle).

In the source 5, electrons are generally accelerated under a voltage between 100 keV and 15 MeV.

In mobile inspection systems, the power of the X-ray source 5 may be e.g., between 100 keV and 9.0 MeV, typically e.g., 300 keV, 2 MeV, 3.5 MeV, 4 MeV, or 6 MeV, for a steel penetration capacity e.g., between 40 mm to 400 mm, typically e.g., 300 mm (12 in).

In static inspection systems, the power of the X-ray source 5 may be e.g., between 1 MeV and 10 MeV, typically e.g., 9 MeV, for a steel penetration capacity e.g., between 300 mm to 450 mm, typically e.g., 410 mm (16.1 in).

In some examples, the source 5 may emit successive x-ray pulses. The pulses may be emitted at a given frequency, between 50 Hz and 1000 Hz, for example approximately 200 Hz.

According to some examples, detectors may be mounted on a gantry, as shown in FIG. 2. The gantry for example forms an inverted “L”. In mobile inspection systems, the gantry may include an electro-hydraulic boom which can operate in a retracted position in a transport mode (not shown on the Figures) and in an inspection position (FIG. 2). The boom may be operated by hydraulic actuators (such as hydraulic cylinders). In static inspection systems, the gantry may include a static structure.

It should be understood that the inspection radiation source may include sources of other penetrating radiation, such as, as non-limiting examples, sources of ionizing radiation, for example gamma rays or neutrons. The inspection radiation source may also include sources which are not adapted to be activated by a power supply, such as radioactive sources, such as using Co60 or Cs137. In some examples, the inspection system includes detectors, such as x-ray detectors, optional gamma and/or neutrons detectors, e.g., adapted to detect the presence of radioactive gamma and/or neutrons emitting materials within the load, e.g., simultaneously to the X-ray inspection. In some examples, detectors may be placed to receive the radiation reflected by the container 4.

In the context of the present disclosure, the container 4 may be any type of container, such as a holder or a box, etc. The container 4 may thus be, as non-limiting examples a palette (for example a palette of European standard, of US standard or of any other standard) and/or a train wagon and/or a tank and/or a boot of the vehicle and/or a “shipping container” (such as a tank or an ISO container or a non-ISO container or a Unit Load Device (ULD) container).

In some examples, one or more memory elements (e.g., the memory of one of the processors) can store data used for the operations described herein. This includes the memory element being able to store software, logic, code, or processor instructions that are executed to carry out the activities described in the disclosure.

A processor can execute any type of instructions associated with the data to achieve the operations detailed herein in the disclosure. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

As one possibility, there is provided a computer program, computer program product, or computer readable medium, including computer program instructions to cause a programmable computer to carry out any one or more of the methods described herein. In example implementations, at least some portions of the activities related to the processors may be implemented in software. It is appreciated that software components of the present disclosure may, if desired, be implemented in ROM (read only memory) form. The software components may, generally, be implemented in hardware, if desired, using conventional techniques.

Other variations and modifications of the system will be apparent to the skilled in the art in the context of the present disclosure, and various features described above may have advantages with or without other features described above. The above embodiments are to be understood as illustrative examples, and further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A method for generating a classifier configured to detect an object corresponding to a type of interest in an inspection image generated using penetrating radiation, the method comprising:
generating training data comprising a plurality of training images comprising objects corresponding to the type of interest, using a generative adversarial network comprising a generator and a discriminator; and
training the classifier by applying a machine learning algorithm, using the generated training data,
wherein generating the training data comprises training the generator and the discriminator using initial training data comprising a plurality of observed images generated using penetrating radiation, one or more observed images comprising an object corresponding to the type of interest.

2. The method of claim 1, wherein generating the training data further comprises generating synthetized objects corresponding to the type of interest, each synthetized object being generated using at least a part of an object in the one or more observed images.

3. The method of claim 2, wherein the generator and the discriminator compete with each other based on a loss function, the loss function comprising at least one of: a least mean square function and/or a combination of weighted Gaussian kernels.

4. The method of claim 3, wherein the combination of the weighted Gaussian kernels comprises a combination C(P,Q,D), such that:
$$𝒞 ( P , Q , D ) = 2 - ( {𝔼}_{x \sim P} [ {\sum }_{k = 1}^{n} {w}_{k} {e}^{- \frac{{( 1 - D ( x ) )}^{2}}{{σ}_{k}^{2}}} ] + {𝔼}_{y \sim Q} [ {\sum }_{k = 1}^{n} {w}_{k} {e}^{- \frac{{D ( y )}^{2}}{{σ}_{k}^{2}}} ] )$$
where: n is the number of kernels,
E[X] is the expectation of function X;
D(x) is the output of the discriminator for an image x,
D(y) is the output of the discriminator for an image y,
P is the probability distribution of the observed images,
Q is the probability distribution of the synthetized images,
(wk) is a set of positive real numbers such that Σwk=1, and
σk is a set of strictly positive numbers acting as standard deviations parameters for the Gaussian kernels.

5. The method of claim 4, wherein the combination C(P,Q,D) comprises a barycenter of any number of Gaussian kernels.

6. The method of claim 1, wherein the generator comprises one or more deconvolution layers and a transposed convolution layer.

7. The method of claim 1, wherein the discriminator comprises one or more convolution layers and a fully connected linear activation layer.

8. The method of claim 2, wherein the inspection image comprises a representation of a container containing the object corresponding to the type of interest,
wherein, in the training of the generator and of the discriminator, one or more observed images comprise a representation of a container, and
wherein generating the training data comprises generating synthetized images using at least a part of a representation of the container in the one or more observed images.

9. The method of claim 8, wherein generating the synthetized images further comprises using one or more synthetized objects.

10. The method of claim 8, wherein generating the synthetized images comprises using a Beer-Lambert law.

11. The method of claim 1, further comprising:
obtaining the observed images,
irradiating, using penetrating radiation, one or more real objects corresponding to the type of interest and/or one or more real containers configured to contain cargo, and
detecting radiation from the irradiated one or more real objects and/or the irradiated one or more real containers, wherein the irradiating and/or the detecting are performed using one or more devices configured to inspect real containers.

12. (canceled)

13. The method of claim 1, wherein the classifier is configured to detect an object corresponding to a type of interest in an inspection image generated using penetrating radiation, the inspection image comprising one or more features at least similar to the training data used to generate the classifier by the machine learning algorithm.

14. The method of claim 1, wherein the classifier comprises a plurality of output states.

15. A method according to claim 1, wherein the method is performed at a computer system separate from a device configured to inspect real containers.

16. A method for determining whether or not an object corresponding to a type of interest is present in an inspection image generated using penetrating radiation, the method comprising:
obtaining an inspection image by:
irradiating, using penetrating radiation, one or more real containers configured to contain cargo; and
detecting radiation from the irradiated one or more real containers;
applying, to the obtained image, a classifier generated by the method according to claim 1; and
determining whether or not an object corresponding to the type of interest is present in the inspection image, based on the applying.

17. (canceled)

18. A method of producing a device configured to determine whether or not an object corresponding to a type of interest is present in an inspection image generated using penetrating radiation, the method comprising:
obtaining a classifier generated by the method according to claim 1; and
storing the obtained classifier in a memory of the device, wherein the storing comprises transmitting the generated classifier to the device via a network, the device receiving and storing the classifier.

19. (canceled)

20. The method according to claim 1, wherein the classifier is generated, stored and/or transmitted in the form of one or more of:
a data representation of the classifier; and/or
executable code for applying the classifier to one or more inspection images.

21. The method according to claim 1, wherein the type of interest comprises at least one of:
a threat, such as a weapon and/or an explosive material and/or a radioactive material; and/or
a contraband product, such as drugs and/or cigarettes.

22. The method according to claim 1, wherein using penetrating radiation comprises irradiating by transmission.

23. A device configured to determine whether or not an object corresponding to a type of interest is present in an inspection image generated using penetrating radiation, the device comprising a memory storing a classifier generated by the method according to claim 1.

24. (canceled)

25. (canceled)
